(19) United States
(12) Patent Application Publication
(10) Pub. No.: US 2010/0275370 A1
(43) Pub. Date: Nov. 4, 2010

(54) DEVICE FOR TURNING OVER A RECUMBENT PERSON

(76) Inventor: Marko Johannes Gerardus Van Loef, Eindhoven (NL)

Correspondence Address: LAW OFFICES OF ERIC KARICH, 2807 ST. MARK DR., MANSFIELD, TX, 76063, US

(21) Appl. No.: 12/434,109

(22) Filed: May 1, 2009

(51) Int. Cl. A61G 7/10

(52) U.S. Cl. 5/81.1 R

(57) ABSTRACT

A device for turning over a recumbent person has devices that can partly enclose the recumbent person. These devices are formed by a strip and end of which is provided with a handle, and an arm, an end of which is pushed under the recumbent person, and a bent end piece. The arm is hinged via a first end to the strip and the end piece is hinged near the middle with the end of the strip turned away from the handle.

### BACKGROUND OF THE INVENTION

1. Field of the invention The invention relates to a device for turning over a recumbent person.

2. Prior art

Recumbent patients who can do little for themselves are common in medical care. These are often sick or elderly people who are almost permanently bedridden. Nursing personnel often have to turn these people into another position in order to carry out a treatment or to be able to wash them for example. Turning the patient onto their side often has to be done for this. This can be a heavy task, considering the high weight of the human body, which is often harmful for a nurse's back.

### SUMMARY OF THE INVENTION

An objective of the invention is to provide a device for turning over a recumbent person, which spares the back of the nursing personnel. For this purpose the device according to the invention is characterized in that it comprises devices that can partly enclose the recumbent person and are provided with a handle. The recumbent person is turned over by moving the handle through an arc. The leverage given by this means that less effort is needed than if no device is used and the nursing personnel can turn over the recumbent person simply and easily.

An embodiment of the device according to the invention is characterized in that the devices comprise an element that is pushed partly under the recumbent person during use. This means that the device can be easily partly placed around the person, which simplifies its use.

A further embodiment of the device according to the invention is characterized in that the devices also comprise a frame on which the element is hinged. The handle is here preferably attached to one of the ends of the frame.

A still further embodiment of the device according to the invention is characterized in that the element is hinged to the frame at a place near the middle between both ends of the frame. The position of the hinge point is here preferably adjustable on the frame between the element and the frame or the frame can be pushed in and out between the end turned away from the handle and the hinge point between the element and the frame. This means the device can be adapted to the size of the person to be turned.

The element is preferably formed by a bent arm, which is hinged to the frame by a first end, whereby the second end of the arm can be pushed under the recumbent person during use.

Moreover the arm is preferably shaped so that there is an angle greater than 60 degrees between an imaginary line through the hinge point of the arm with the frame to the second end of the arm and the section of the arm that adjoins the second end. This means there is little chance that the arm can slip out from under the person to be turned during use. This imaginary line is preferably virtually perpendicular to the section of the arm that adjoins the second end.

The frame is preferably formed by a strip to provide a robust device.

Again a further embodiment of the device according to the invention is characterized in that the devices also comprise a bent end piece, which is hinged near the middle to the end of the handle that is turned away from the frame. This means the devices can enclose a recumbent person to a greater extent and more efficiently. The end piece is preferably present on the same side of the frame as the element and a first section of the end piece extends along the frame and a second section extends beyond the end of the frame.

A further embodiment of the device according to the invention is characterized in that the devices comprise two rollers that are connected to the frame at a distance from each other, and a belt that extends between the rollers and is guided by them. This allows the recumbent person to be turned more comfortably. The belt can be disconnected in order to attach the device. The belt can be slackened when attaching the device so that it adapts to the form of the recumbent person's body. The belt can be blocked again for the turning operation. The belt distributes the force exerted more efficiently over the recumbent person's body, so that virtually no undesirable pressure points occur that can injure the recumbent person.

The element is preferably hinged to the frame near one of the rollers. The device can thus be attached with extra ease and comfort. The element and the frame can be bent apart for attachment of the device. The element can then be pushed under the recumbent person. The element and the frame can then be bent together so that the device partly encloses and virtually lies over the recumbent person's body. This measure means that the element can be pushed under the recumbent person more easily without the rest of the device being in the way or rubbing along the recumbent person's body.

A still further embodiment of the device according to the invention is characterized in that the device comprises a bent catch that is connected to the element and which can be used to turn the element with respect to the frame. This bent catch simplifies the work of the personnel further and saves the exertion of force. The element and the frame can be bent apart more easily and with less effort by using this bent catch.

The device preferably comprises a locking mechanism that is used to lock the bent catch. This measure makes the device more comfortable to use. This can lock the bent catch in the desired position, after which the device can be used as a single object.

Again a further embodiment of the device according to the invention is characterized in that it comprises a carriage that has a sliding connection to the frame and on which one of the rollers is present, so that the device can be adapted to the shape of the recumbent person's body. This means a recumbent person can be turned more comfortably. As the shape and size of the device matches the body's shape, the pressure of the device will be distributed evenly over the body and the recumbent person will not be easily injured.

The belt is preferably connected to a self-winding spring so that it is always taut. The belt will thus always adapt to the recumbent person's body so that turning can be done more comfortably and the chance of injury is even less.

### BRIEF DESCRIPTION OF THE DRAWINGS

The invention will be elucidated more fully below on the basis of drawings in which embodiments of the device for turning over a recumbent person are shown. In these drawings:

FIG. 1 shows a first embodiment of the device in sections;

FIG. 2 shows the device shown in FIG. 1 whilst the arm is pushed under a recumbent person;

FIG. 3 shows the device shown in FIG. 1 when the recumbent person is enclosed;

FIG. 4 shows the situation when the person is being turned;

FIG. 5 is a diagram of a second embodiment of the device according to the invention when opened;

FIG. 6 shows the device shown in FIG. 5 when placed under a person lying on his back;

FIG. 7 shows the device shown in FIG. 5 placed under a person who is turned partly on his side; and

FIG. 8 shows the device shown in FIG. 5 placed under a person who is turned completely on his side.

### DETAILED DESCRIPTION OF THE DRAWINGS

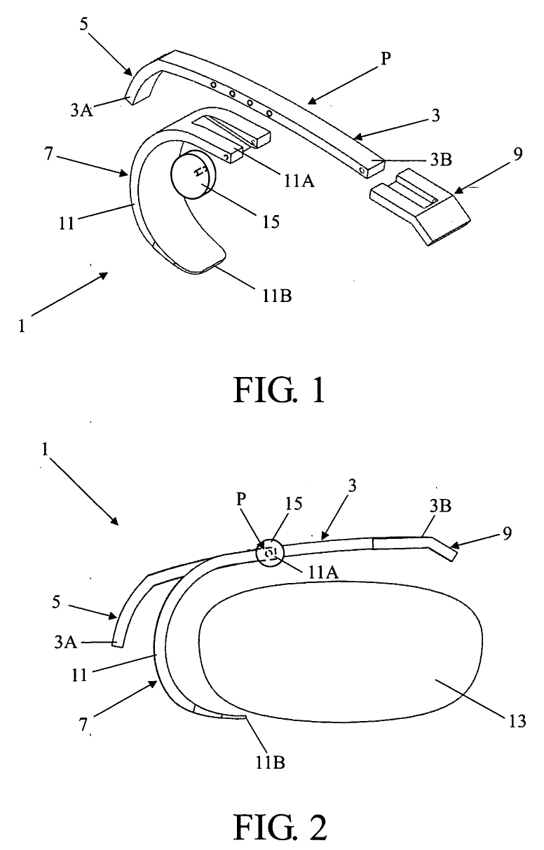

FIG. 1 shows an embodiment of the device according to the invention in sections. The device 1 comprises devices that can partly enclose a recumbent person. These devices are formed by a strip 3, an end 3A of which is provided with a handle 5, and an element 7, an end of which can be pushed under the recumbent person during use, and a bent end piece 9.

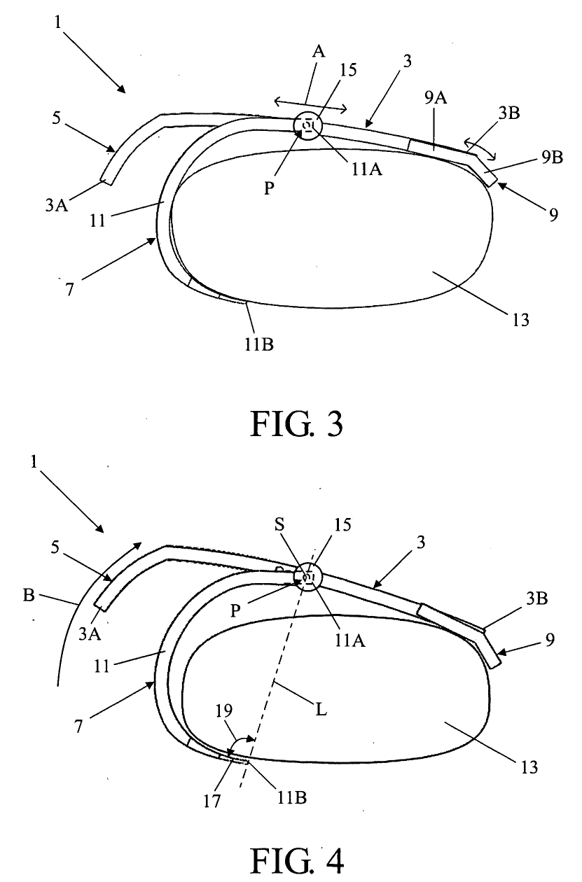

The element 7 is formed by a bent arm 11, which is hinged via a first end 11A to the strip 3 at a place P near the middle between both ends of the strip. The second, free end 11B of the arm is pushed under the recumbent person 13 during use, see FIG. 2. The place P of the first end 11A of the arm 11 on the strip 3 can thus be adjusted, see arrow A in FIG. 3, and can be fixed with respect to the strip by a knob 15. This means the device 1 can be adapted to the size of the person 13 to be turned.

The end piece 9 is hinged near the middle to the end of the handle 3B turned away from the strip 3. The bent arm 11 and the end piece 9 are thus present on the same side of the strip 3. A first section 9A of the end piece extends along the strip 3 and a second section 9B extends past the end of the strip 3. The second section 9B can thus not turn towards the arm 11 without limit, but it can turn away from the arm.

An angle 19 is formed between an imaginary line L through the hinge point S of the arm with the strip 3 to the second end 11B of the arm, see FIG. 4, and a section 17 adjoining the second end 11B. This angle 19 is greater than 60 degrees and is preferably 90 degrees, as in this embodiment, or approximately 90 degrees (i.e. between 80 and 100 degrees). This means there is little chance that the arm 11 will slip out from under the person to be turned 13 when the device is being turned in the direction of arrow B.

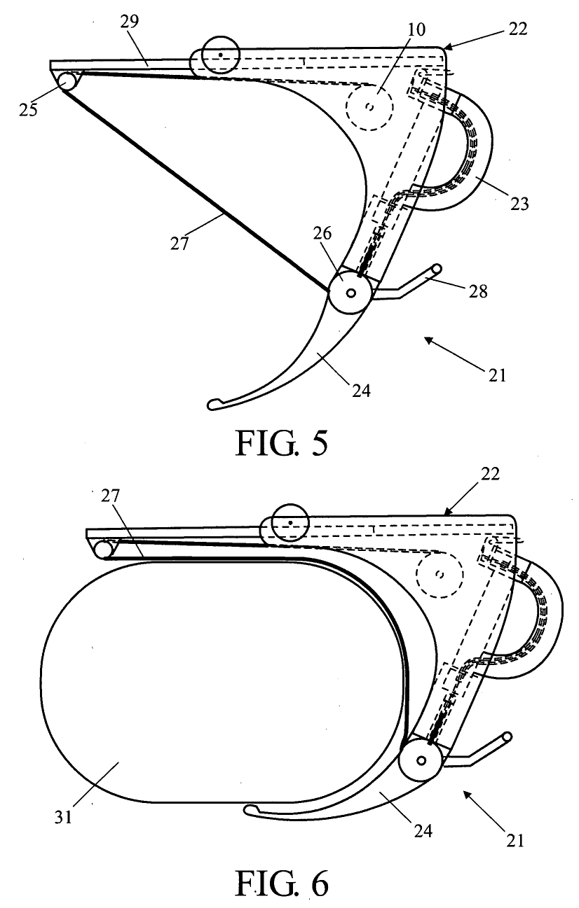

FIGS. 5 to 8 show four positions of a second embodiment of the device according to the invention during use. FIG. 1 shows the device 21 opened. The device 21 has a frame 22 and an element 24 hinged to it. The element 24 can be pushed under the recumbent person and turned with a bent catch 28 with respect to the frame 22. The device 21 in this embodiment has a handle 23 with which the device 21 can be handled. There is also a carriage 29 that has a sliding connection with the frame 22. A belt 27 extends between two rollers 25 and 26, which are connected to the carriage 29 and the frame 22 respectively. The belt 27 is led along the rollers 25 and 26 during use. The belt 27 is connected to a self-winding spring 30, which keeps the belt 27 taut.

FIG. 6 shows the device 21 during use, in which the element 24 is pushed under a person lying on his back 31. The belt 27 is here put around the recumbent person 31, and the frame 22 and the element 24 are bent towards each other.

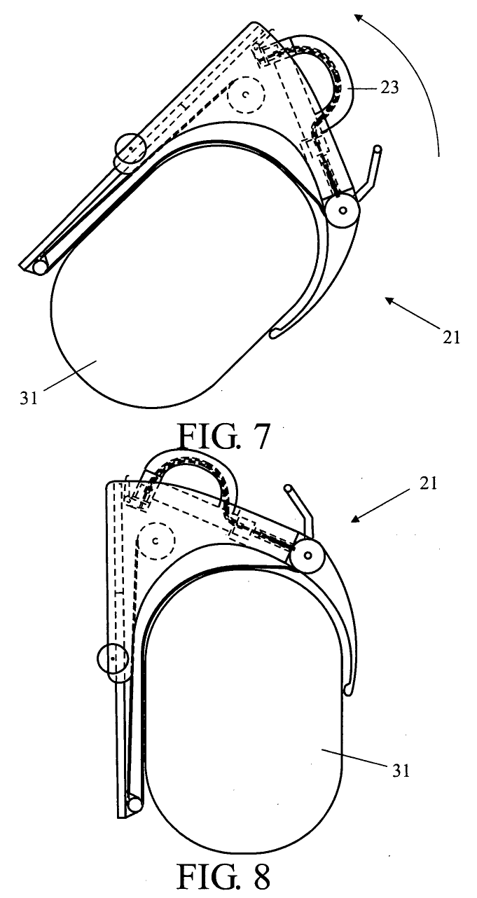

FIG. 7 shows the situation during use in which the recumbent person 31 is partly turned on his side. The bent arrow indicates the direction in which a user has to turn the handle 23.

FIG. 8 shows the situation during use in which the recumbent person 31 is turned completely onto his side.

Although in the above the invention is explained on the basis of the drawings, it should be noted that the invention is in no way limited to the embodiments shown in the drawings. The invention also extends to all embodiments deviating from the embodiments shown in the drawings within the context defined by the claims.

1. Device for turning over a recumbent person, the device comprising: devices that can partially enclose a recumbent person and are provided with a handle.

2. Device according to claim 1, characterized in that the devices comprise an element that can be partly pushed under the recumbent person during use.

3. Device according to claim 2, characterized in that the devices also comprise a frame to which the element is hinged.

4. Device according to claim 3, characterized in that the handle is present on one of the ends of the frame.

5. Device according to claim 3, characterized in that the element is hinged to the frame near the middle between the both ends of the frame.

6. Device according to claim 3, characterized in that the position of the hinge point on the frame can be adjusted between the element and the frame.

7. Device according to claim 4, characterized in that the frame can be pushed in and out between the end turned away from the handle and the hinge point between the element and the frame.

8. Device according to claim 2, characterized in that the element is formed by a bent arm, a first end of which is hinged to the frame, in which the second end of the arm is pushed under the recumbent person during use.

9. Device according to claim 8, characterized in that there is an angle greater than 60 degrees between an imaginary line through the hinge point of the arm with the frame to the second end of the arm and the section of the arm adjoining the second end.

10. Device according to claim 9, characterized in that the imaginary line is virtually perpendicular to the section of the arm adjoining the second end.

11. Device according to claim 3, characterized in that the devices also comprise a bent end piece that is hinged near the middle to the end of the frame turned away from the handle.

12. Device according to claim 1 1, characterized in that the end piece is present on the same side of the frame as the element and a first section of the end piece extends along the frame and a second section extends beyond the end of the frame.

13. Device according to claim 3, characterized in that the devices comprise two rollers connected to the frame at a distance from each other, and a belt that extends between the rollers and is guided by them.

14. Device according to claim 13, characterized in that the element is hinged to the frame near one of the rollers.

15. Device according to claim 13, characterized in that the device comprises a bent catch that is connected to the element and with which the element can be turned with respect to the frame.

16. Device according to claim 15, characterized in that the device comprises a locking mechanism with which the bent catch can be locked.

17. Device according to claim 13, characterized in that the device comprises a carriage that has a sliding connection to the frame and on which one of the rollers is present, so that the device can be adapted the body size of the recumbent person.

18. Device according to claim 13, characterized in that the belt is connected to a self-winding spring so that it is always taut.

19. Device for turning over a recumbent person, the device comprising:
an element adapted to be partly pushed under the recumbent person;
a frame to which the element is hinged, the frame having opposed ends; and
a handle on one of the ends of the frame.

20. Device for turning over a recumbent person, the device comprising:
an element adapted to be partly pushed under the recumbent person;
a frame to which the element is hinged, the frame having opposed ends;
a handle on one of the ends of the frame;
characterized in that the frame can be pushed in and out between the end turned away from the handle and the hinge point between the element and the frame;
wherein the element is formed by a bent arm, a first end of which is hinged to the frame, in which the second end of the arm is pushed under the recumbent person during use;
wherein there is an angle greater than 60 degrees between an imaginary line through the hinge point of the arm with the frame to the second end of the arm and the section of the arm adjoining the second end, and wherein the imaginary line is virtually perpendicular to the section of the arm adjoining the second end;
a bent end piece that is hinged near the middle to the end of the frame turned away from the handle;
wherein the end piece is present on the same side of the frame as the element and a first section of the end piece extends along the frame and a second section extends beyond the end of the frame;
two rollers connected to the frame at a distance from each other, and a belt that extends between the rollers and is guided by them; and
wherein the element is hinged to the frame near one of the rollers.
